(19) United States
(12) Patent Application Publication
(10) Pub. No.: US 2025/0161842 A1
(43) Pub. Date: May 22, 2025

(54) PURIFICATION OF ALKALINE ELECTROLYTES

(71) Applicant: Form Energy, Inc., Somerville, MA (US)

(72) Inventors: Alex Luyima, Burlington, MA (US); Joseph Stephen Manser, Lowell, MA (US)

(21) Appl. No.: 18/793,146

(22) Filed: Aug. 2, 2024

Related U.S. Application Data
(60) Provisional application No. 63/668,847, filed on Jul. 9, 2024.
(60) Provisional application No. 63/547,822, filed on Nov. 8, 2023.
(60) Provisional application No. 63/531,289, filed on Aug. 7, 2023.

(51) Int. Cl. B01D 15/36; B01D 21/01; C25C 1/06; C25C 7/06

(52) U.S. Cl. CPC B01D 15/363; B01D 21/01; C25C 1/06; C25C 7/06

(57) ABSTRACT

A method of purifying an alkaline electrolyte includes contacting the alkaline electrolyte with an aluminum compound to provide a purified alkaline electrolyte. The alkaline electrolyte includes a metal hydroxide, a compound comprising aluminum, silicon, or a combination thereof, and a solvent. The method can be particularly advantageous when used with a method of processing an iron-containing feedstock.

### CROSS REFERENCE TO RELATED APPLICATIONS

This application claims priority to U.S. Provisional Patent Application No. 63/531,289, filed on Aug. 7, 2023, U.S. Provisional Patent Application No. 63/547,822, filed on Nov. 8, 2023, and U.S. Provisional Patent Application No. 63/668,847, filed on Jul. 9, 2024, the contents of each of which are hereby incorporated by reference in their entirety.

### BACKGROUND

This disclosure generally relates to methods and systems for the purification of alkaline electrolytes. In a specific aspect, the disclosure relates to purification and use of purified alkaline electrolytes in an iron electrolysis process.

The iron and steel industry is responsible for approximately 10% of global carbon dioxide (CO₂) emissions and is the largest industrial consumer of coal. In order to meet global energy and climate goals, the steel industry must incorporate emerging near-zero emission steelmaking technologies into its development plan. A promising direction for reducing CO₂ emissions is the electrolytic reduction of iron oxide in alkaline solutions at moderate temperatures.

There remains a continuing need for improved methods to produce iron metal from iron-containing feedstocks, such as iron ores. It would be particularly advantageous to provide methods for purifying alkaline electrolytes and using the purified alkaline electrolytes in the electrolytic reduction of iron oxide.

### BRIEF DESCRIPTION

An aspect of the present disclosure is a method of purifying an alkaline electrolyte, the method comprising: providing the alkaline electrolyte, wherein the alkaline electrolyte comprises a metal hydroxide, a compound comprising aluminum, silicon, or a combination thereof, and a solvent; and contacting the alkaline electrolyte with an aluminum compound to provide a purified alkaline electrolyte.

Another aspect is a method of processing an iron-containing feedstock to produce an iron particle, the method comprising: continuously flowing an alkaline electrolyte stream comprising the iron-containing feedstock through a channel of an electrochemical cell, the electrochemical cell comprising an anode, and a cathode disposed in the channel; electrochemically reducing at least a portion of the iron-containing feedstock to produce a plurality of iron particles at a surface of the cathode; separating at least a portion of the plurality of iron particles from the alkaline electrolyte; purifying the alkaline electrolyte to provide a purified alkaline electrolyte; and recycling the purified alkaline electrolyte to the alkaline electrolyte stream to process the iron-containing feedstock.

Another aspect is an alkaline electrolyte purifier, comprising a mixing unit having a first inlet configured to receive an alkaline electrolyte feedstock, the alkaline electrolyte feedstock comprising a metal hydroxide, a compound comprising aluminum, silicon, or a combination thereof, and a solvent, a second inlet configured to receive a precipitant comprising an aluminum compound, and an outlet configured to provide a slurry; and a first separator configured to separate the slurry and provide a solid component and a first alkaline electrolyte stream.

The above and other aspects and features are described and exemplified by the following figures and detailed description.

### BRIEF DESCRIPTION OF THE DRAWINGS

The following figures are exemplary embodiments wherein the like elements are numbered alike.

FIG. 1 is a schematic diagram for a purification process according to an aspect of the present disclosure.

FIG. 2 is a schematic diagram for a reactor and method for processing an iron-containing feedstock according to an aspect of the present disclosure.

FIG. 3 shows results of a thermodynamic simulation of a purification process according to an aspect of the disclosure using OLI Studio 11.5.

FIG. 4 shows results of a thermodynamic simulation of a purification process according to an aspect of the disclosure using OLI Studio 11.5.

FIG. 5 shows results of a thermodynamic simulation of a purification process according to an aspect of the disclosure using OLI Studio 11.5.

FIG. 6 shows results of a thermodynamic simulation of a purification process according to an aspect of the disclosure using OLI Studio 11.5.

FIG. 7 shows the stability diagram of dissolved silicon (Si⁴⁺) and aluminum (Al³⁻) obtained from thermodynamic simulations using OLI Studio 11.5.

FIG. 8 shows the stability diagram of dissolved silicon (SiO₂) and aluminum (Al₂O₃) obtained from thermodynamic simulations using OLI Studio 11.5.

FIG. 9 shows OLI Studio 11.5 simulations of sodium silicate crystallization at high concentrations of NaOH.

FIG. 10 shows the experimental results obtained from purifying various concentrations of NaOH solutions.

FIG. 11 shows results of a thermodynamic simulation of a purification process according to an aspect of the disclosure using OLI Studio 11.5.

FIG. 12 shows results of a simulation of a purification process according to an aspect of the disclosure using OLI Studio 11.5.

### DETAILED DESCRIPTION

The present disclosure relates to methods and systems for purification of an alkaline electrolyte. In a particularly advantageous feature, the method of purifying the alkaline electrolyte may be used in conjunction with a method for processing an iron-containing feedstock (e.g., electrolytic reduction of iron oxide). A significant improvement is therefore provided by the present disclosure.

Accordingly, an aspect of the present disclosure is a method of purifying an alkaline electrolyte. The method comprises contacting the alkaline electrolyte with an aluminum compound to provide a purified alkaline electrolyte.

The alkaline electrolyte (i.e., prior to any purification) comprises a metal hydroxide, a compound comprising aluminum, silicon, or a combination thereof, and a solvent. In an aspect, the alkaline electrolyte may be in the form of an aqueous solution (e.g., wherein the solvent is water). The metal hydroxide can be an alkali metal hydroxide, for example sodium hydroxide, potassium hydroxide, lithium hydroxide, cesium hydroxide, or a combination thereof. In a specific aspect, the metal hydroxide can be sodium hydroxide.

The alkaline electrolyte can have a pH of 9 to 17.5. In an aspect, the alkaline electrolyte can have a total hydroxide concentration of greater than 1 molar, preferably 2 molar to 17.5 molar, or 2 molar to 15 molar, more preferably 4 molar to 17.5 molar, or 4 molar to 8 molar, each based on a total volume of the alkaline electrolyte. In an aspect, the alkaline electrolyte can have a total hydroxide concentration of less than 10 molar, preferably 2 molar to 9 molar, more preferably 4 molar to 8 molar, each based on a total volume of the alkaline electrolyte. In an aspect, the alkaline electrolyte can have a total hydroxide concentration of 5 molar to 20 molar, or 10 molar to 20 molar, or 10 molar to 19 molar, or 10 molar to 17.5 molar, each based on a total volume of the alkaline electrolyte.

The alkaline electrolyte further comprises a compound comprising aluminum, silicon, or a combination thereof. For example, the alkaline electrolyte can further comprise Al₂O₃·2SiO₂·2H₂O, SiO₂, Al(OH)₃, (MgₓFe₁₋ₓ)₃Si₄O₁₀(OH)₂ wherein 0≤x≤1, KAlSi₃O₈₇, (KₘNaₙCaₒ)0.6(MgₚFe²⁺_{q}Fe³⁺_{1-q})6Si₈Al(OₛOH₁₋ₛ)₂₄·2H₂O wherein 0≤m≤1, 0≤n≤1, 0≤o≤1 and m+n+o=1, 0≤p≤1, 0≤q≤1, and p+q=1, and 0≤s≤1, NaAlSi₃O₈, or a combination thereof. In an aspect, the compound comprising aluminum, silicon, or a combination thereof comprises a silicon oxide. Such compounds are readily dissolved in caustic solutions, such as the alkaline electrolyte solution, and the alkaline electrolyte can therefore require purification prior to use (i.e., to remove of reduce the concentration of the compound comprising aluminum, silicon, or a combination thereof). The aforementioned compounds comprising aluminum, silicon, or a combination thereof can be impurities, for example from iron ores. For example, when used in a method of treating an iron ore feedstock, such impurities can be dissolved in an alkaline electrolyte, thus contaminating the electrolyte and providing the present alkaline electrolyte comprising a compound comprising aluminum, silicon, or a combination thereof.

In some aspects, the alkaline electrolyte can comprise aluminum, and can be, for example, an alkaline electrolyte from an alkaline iron electrowinning process. For example, the alkaline electrolyte can comprise relatively low concentrations of dissolved aluminum. In an aspect, the alkaline electrolyte can have a dissolved Al₂O₃ concentration of less than 100 grams per liter (g/L). Within this range, the dissolved Al₂O₃ concentration in the alkaline electrolyte can be less than 75 g/L, or less than 60 g/L, or less than 50 g/L, or less than 40 g/L or less than 30 g/L, or less than 20 g/L, or less than 10 g/L, or 0 to 100 g/L, or greater than 0 to 100 g/L, or greater than 0 to 75 g/L, or greater than 0 to 60 g/L, or greater than 0 to 50 g/L, or 5 to 100 g/L, or 5 to 75 g/L, or 5 to 50 g/L, or 5 to 40 g/L, or 5 to 30 g/L. As used herein, the term “aluminate” is used to refer to dissolved aluminum compounds in the electrolyte including but not limited to sodium aluminate. While the foregoing dissolved Al₂O₃ concentrations may be preferred, concentration outside the foregoing ranges are also contemplated by the present disclosure. For example, the dissolved Al₂O₃ concentration may be greater than 100 g/L.

The alkaline electrolyte can optionally further comprise an anionic impurity. Representative anionic impurities can include anionic impurities comprising SO₄²⁻, CO₃²⁻, C₂O₄²⁻, 2Al(OH)₄⁻, 2Cl⁻, 2OH⁻, F⁻, or a combination thereof.

The method according to the present disclosure comprises contacting the alkaline electrolyte with an aluminum compound to provide a purified alkaline electrolyte. It is noted that “the aluminum compound” used in the method is different from “the compound comprising aluminum” that may be present in the initial alkaline electrolyte feedstock. The aluminum compound can comprise, for example, aluminum oxide, aluminum hydroxide, sodium aluminate, kaolin, calcium aluminate, other metal aluminates, or a combination thereof. Without wishing to be bound by theory, it is believed that contacting the alkaline electrolyte with the aluminum compound can form a zeolite type phase (sodium aluminosilicate compound or desilication product (DSP)). In an aspect, the aluminum compound, when contacted with the compound comprising aluminum, silicon, or a combination thereof, forms an aluminum compound, a silicon compound, an aluminosilicate compound, or a combination thereof, preferably an aluminosilicate compound. This is expressed by Equation (1):

6NaAl(OH)₄+6Na₂SiO₃+Na₂X→Na₆[Al₆Si₆O₂₄]·3(H₂O)+12NaOH+3H₂O (1)

wherein X is an anionic impurity that may be SO₄²⁻, CO₃²⁻, C₂O₄²⁻, 2Al(OH)₄⁻, 2Cl⁻, 2OH⁻, F⁻, etc.

The reaction according to Equation (1) may help to remove aluminum and silicate impurities contained in an alkaline electrolyte to enable re-use or enable use of the alkaline electrolyte solution in other applications.

The aluminum compound can be contacted with the alkaline electrolyte in an amount effective to provide the purified alkaline electrolyte. For example, the aluminum compound can be contacted with the alkaline electrolyte in an amount effective to provide weight ratio of aluminum compound:dissolved silicon of 0.75:1 to 1.75:1.

Advantageously, the aluminum compound, silicon compound, aluminosilicate compound, or a combination thereof formed by the contact of the alkaline electrolyte with the aluminum compound can precipitate from the alkaline electrolyte. In an aspect, an aluminosilicate compound can precipitate from the alkaline electrolyte. Formation of a precipitate can facilitate separation from the alkaline electrolyte, for example, using a variety of solid-liquid separation techniques (e.g., filtration, centrifugation, and the like).

In some aspects, a silicate compound may be added to the alkaline electrolyte to reduce the amount of dissolved alumina and effect aluminum removal from the electrolyte.

The contacting can be conducted under conditions effective to provide the purified alkaline electrolyte. For example, the contacting can be at a temperature of 50 to 200° C., at a pressure of greater than or equal to 1 atmosphere, or a combination thereof.

The alkaline electrolyte can optionally be further contacted with an alkaline earth metal compound, for example a calcium compound. In an aspect, a calcium compound, for example calcium hydroxide or calcium oxide or any oxide of calcium can be added in combination with aluminum hydroxide (or oxide or sodium aluminate) to increase the efficiency of purification and desilication reaction.

In an aspect, the method can optionally further comprise contacting the alkaline electrolyte with activated carbon. Contacting with activated carbon may be useful to further purify and remove dissolved impurities like Cl⁻, F⁻, CO₃²⁻, ClO₄⁻, Fe(OH)₄⁻ and/or Fe(OH)₃⁻, and residual Si⁴⁺ and Al³⁺ species in cases where the alkaline electrolyte is needed for other applications.

In an aspect, the method can optionally further comprise contacting the alkaline electrolyte with an ion exchange resin. Contacting with an ion exchange may be useful to further purify and remove dissolved impurities like Cl⁻, F, CO₃²⁻, ClO₄⁻, Fe(OH)₄⁺ or Fe(OH)₃−, and residual Si⁴⁺ and Al³⁺ species in cases where the alkaline electrolyte is needed for other applications.

In an aspect, the method can optionally further comprise crystallization. For example, crystallization may be used to further purify and remove dissolved impurities such as Cl⁻, F⁻, CO₃²⁻, ClO₄⁻, Fe(OH)₄⁻ and/or Fe(OH)₃⁻, and residual Si⁴⁺ and Al³⁺ species in cases where the alkaline electrolyte is needed for other applications.

In an aspect, the method can optionally further comprise contacting the alkaline electrolyte with sodium carbonate. Contacting with sodium carbonate may be used to further purify and remove dissolved calcium.

The purified alkaline electrolyte can have a residual silicon concentration of less than 0.02 molar, based on a total volume of the alkaline electrolyte. The purified alkaline electrolyte can have a residual aluminum concentration of less than 0.11 molar, based on a total volume of the alkaline electrolyte. In an aspect, the purified alkaline electrolyte can have a residual silicon concentration that is 10% or less, or 5% or less, or 2% or less, or 1% or less of an initial concentration of the compound comprising silicon.

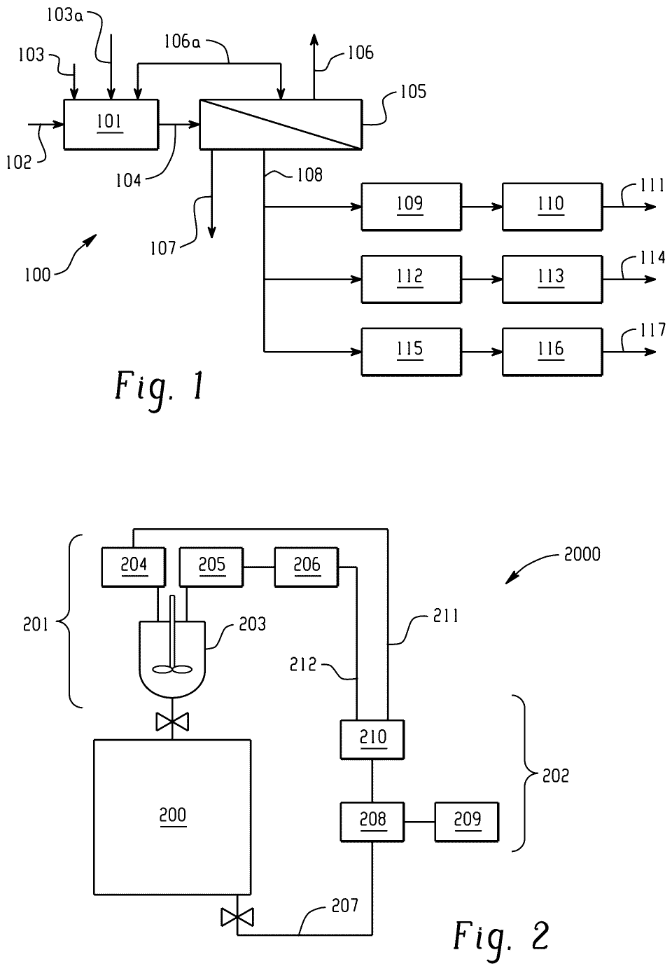

Another aspect of the present disclosure is an alkaline electrolyte purifier. An alkaline electrolyte purifier according to an aspect of the disclosure can be as shown in FIG. 1. As shown in FIG. 1, an alkaline electrolyte purifier 100 comprises a mixing unit 101 having a first inlet 102 and a second inlet 103. The first inlet 102 is configured to receive an alkaline electrolyte feedstock. The alkaline electrolyte feedstock comprises a metal hydroxide, a compound comprising aluminum, silicon, or a combination thereof, and a solvent. The second inlet 103 is configured to receive a precipitant comprising an aluminum compound. The alkaline electrolyte feedstock and the precipitant comprising the aluminum compound are provided to the mixing unit 101. In an aspect, the mixing unit may further comprise a third inlet 103a which, when present, is configured to provide an alkaline earth metal compound (e.g., calcium oxide or calcium hydroxide) to the mixing unit 101. The mixing unit further comprises an outlet 104 configured to provide a slurry obtained from the mixing unit to a first separator 105 configured to separate the slurry and provide a solid component 106 and a first alkaline electrolyte stream 107. In some aspects, a portion of the solid component provided by the first separator 105 can be transferred back to the mixing unit 101 (e.g., to act as a seed for precipitation), shown as stream 106a in FIG. 1. In an aspect, the first separator 105 can comprise an outlet 108 which is configured to provide separated alkaline electrolyte to one or more further purification steps. For example, separated alkaline electrolyte may be further provided to an ion exchange unit 109 configured to receive an alkaline electrolyte stream from the first separator to provide a second alkaline electrolyte stream 111 after passing through a second separator 110. In an aspect, separated alkaline electrolyte may be further provided to an adsorption unit 112 configured to receive the first alkaline electrolyte stream from the first separator, wherein the adsorption unit comprises activated carbon; and a second separator configured to separate the first alkaline electrolyte stream and the activated carbon and provide a third alkaline electrolyte stream 114 after passage through a third separator 113. In an aspect, separated alkaline electrolyte may be further provided to a crystallization unit 115 configured to receive the first alkaline electrolyte stream from the first separator, and a fourth separator 116 configured to separate crystallized product and provide high purity metal hydroxide as a crystallized product 117. It is noted that alternative arrangements of components 101, 105, 109, 112 and 115 are possible other than what is shown in FIG. 1. For example, these operations can be connected in series and in different combinations to provide the purified alkaline electrolyte.

The method for purification of an alkaline electrolyte can be particularly useful in processing of iron-containing feedstocks. Accordingly, a method of processing an iron-containing feedstock represents another aspect of the present disclosure. For convenience the term “iron-containing feedstock” is used, although any suitable feedstock including an iron compound in an oxidized state may be used. The term “iron ore” may be substituted or interchanged for the term “iron-containing feedstock.” The iron-containing feedstock is further described below.

The method of processing an iron-containing feedstock comprises continuously flowing an alkaline electrolyte stream comprising the iron-containing feedstock through a channel of an electrochemical cell. The electrochemical cell comprises an anode, and a cathode disposed in the channel.

The anode of the electrochemical cell includes a suitable anode current collector. The anode current collector may be a metal, metal alloy, or a combination thereof. In an aspect, the anode may include lead, nickel, platinum, iridium, ruthenium, tantalum, titanium, an alloy thereof, or a combination thereof. In an aspect, the anode current collector may be coated with mixed metal oxides of iridium, ruthenium, tantalum, or the like, or a combination thereof.

In an aspect, the anode may include a catalyst. Exemplary catalysts include metal oxide catalysts, such as manganese oxide (MnO₂, Mn₂O₃, Mn₃O₄, MnₓO_{y} (where x=1 to 3 and y=1 to 8)), nickel-doped manganese oxide (Ni—MnₓO_{y}), nickel oxide (NiOₓ), nickel oxyhydroxide (NiOₓ(OH)_{y}), iron oxide (FeOₓ), iron oxyhydroxide (FeOₓ(OH)_{y} (where x=0 to 2 and y=0 to 3)), cobalt oxide (CO₃O₄, CoₓO_{y} (where x=1 to 3 and y=1 to 8)), manganese cobalt oxide (MnCo₂O₄, Mn₁₊ₓCo₂₋ₓO₄ (where x=0 to 2)), cobalt manganese oxide (CoMn₂O₄), nickel manganese oxide (NiMnOₓ (where x=2 to 4)), manganese iron oxide (MnFe₂O₄, Mn₁₊ₓFe₂₋ₓO₄ (where x=0 to 1)), nickel-doped manganese oxide (Ni—MnₓO_{y}(where x=1 to 3 and y=1 to 8)), manganese cobalt iron oxide (MnₓCo_{y}Fe_{z}O₄ (where x=0 to 4 and y=0 to 4 and z=0 to 4)), zinc cobalt manganese oxide (ZnCoMnO₄, ZnₓCo_{y}Mn_{z}O₄ (where x=0 to 4 and y=0 to 4 and z=0 to 4)), cobalt nickel oxide (CoNiOₓ (where x=0 to 4)), calcium manganese oxide (CaMnOₓ (where x=0 to 4)), lanthanum manganese oxide (LaMnO₃), lanthanum cobalt oxide (LaCo₂O₄, La₁₊ₓCo₂₋ₓO₄ (where x=0 to 2), lanthanum nickel oxide (LaNiO₃), lanthanum calcium aluminum manganese oxide (LaₓCa_{y}Al_{z}MnᵥO₃ (where x=0 to 3 and y=0 to 3 and z=0 to 2 and v=0 to 3)), nickel iron oxide (Ni_{z}Fe_{1-z}Oₓ(where z=0 to 1 and x=0.5 to 2.5)), manganese ferrite (MnFe₂O₄), zinc ferrite (ZnFe₂O₄), nickel cobaltite (NiCo₂O₄), lanthanum strontium manganate (La_{0.8}Sr_{0.2}MnO₃), or the like, other transition metal oxides or nitrides (such as Fe₃N, FeCN, ZrN, Mn₄N, or a combination thereof), or a combination thereof. The particles of the catalyst may be coated by electrodeposition, electroless plating, or other chemical deposition process(es); for example, atomic layer deposition (ALD), thermal evaporation, sputtering, spray pyrolysis, solution-based deposition, hot dip coating, inkjet printing, or a combination thereof.

The anode current collector may have a thickness of 0.05 to 0.5 centimeters (cm), or 0.1 to 0.3 cm. In an aspect, the anode current collector may be at least partially porous.

The electrochemical reactor also includes a cathode. The cathode includes a suitable cathode current collector. Preferably, the current collector of the cathode is selected to minimize or prevent adhesion of the iron-containing feedstock or the iron metal thereto. Exemplary materials that are suitable for use in the cathode include, but are not limited to, aluminum, carbon, molybdenum, nickel, titanium, iron, an alloy thereof, or a combination thereof. In an aspect, the cathode current collector may include steel, graphite, nickel, iron, a nickel-iron alloy, or a combination thereof. In some embodiments, the cathode may further include an inert conductive matrix including carbon black, graphite powder, charcoal powder, coal powder, nickel-coated carbon steel mesh, nickel-coated stainless-steel mesh, nickel-coated steel wool, or the like, or a combination thereof.

In an aspect, the cathode may further include one or more additive(s) to enhance the electronic or physical properties of the cathode. In an aspect, the additive in the cathode may include one or more of bismuth (III) oxide (Bi₂O₃), bismuth (III) sulfide (Bi₂S₃), barium oxide (BaO), barium sulfate (BaSO₄), barium hydroxide (Ba(OH)₂), calcium oxide (CaO), calcium sulfate (CaSO₄), calcium hydroxide (Ca(OH)₂), magnesium oxide (MgO), magnesium hydroxide (Mg(OH)₂), carbon nanotubes, carbon nanofibers, graphene, or a combination thereof.

In an aspect, the cathode may further include one or more binder compound(s). When present, the binder compound may include polytetrafluoroethylene (PTFE), polyvinylidene difluoride (PVDF), polypropylene (PP), polyethylene (PE), polyacrylonitrile (PAN), a styrene-butadiene rubber, sodium carboxymethyl cellulose (Na-CMC), or the like, or a combination thereof.

The cathodic material may be positively charged or negatively charged. The cathodic material may be charged by a direct current (“DC”) source, by an alternating current (“AC”) source, or by a pulsed current.

The cathode current collector may have a thickness of 0.05 to 0.5 cm, or 0.1 to 0.3 cm. In an aspect, the cathode current collector may be at least partially porous.

The interelectrode gap may also be varied, with a well-known impact on the ohmic drop. In an aspect, the interelectrode gap may be 1 to 100 millimeters (mm). For example, the interelectrode gap may be 2 to 50 mm, or 3 to 30 mm, or 4 to 20 mm.

In an aspect, the voltage of the electrochemical cell may be 1.5 to 5.0 Volts (V), preferably 1.6 to 2.9 V, and more preferably 1.7 to 2.8 V. In still other aspects, the voltage of the electrochemical cell may be 2.6 to 5.0 V, or 2.8 to 4.0 V. The mechanism for optimizing cell voltage within the electrochemical cell will vary in accordance with various exemplary aspects described herein. Moreover, the overall cell voltage achievable is dependent upon a number of other interrelated factors, including reaction chemistry, electrode spacing, the configuration and materials of construction of the electrodes, the configuration and materials of construction of the separators, electrolyte concentrations and iron concentration in the electrolyte, current density, electrolyte temperature, and, to a smaller extent, the nature and amount of any additives to the electrochemical process (such as, for example, flocculants, surfactants, or the like).

The iron-containing feedstock may include any suitable iron compound, and may include one or more oxides of iron. The iron-containing feedstock refers to an iron-containing material that is capable of undergoing reduction reactions during operation of the electrochemical reactor. As used herein, the terms “iron ore” and “iron-containing feedstock” may be used synonymously to refer to iron-containing materials that may be used as inputs into the various systems and methods described herein. “Iron ores” and “iron-containing feedstocks” may include iron in any form, such as iron oxides, hydroxides, oxyhydroxides, carbonates, or other iron-containing compounds, ores, rocks, or minerals, including any mixtures thereof, in naturally-occurring states or purified states. The iron-containing feedstock may include materials recognized, known, or referred to in the art as iron ore(s), rock(s), natural rock(s), sediment(s), natural sediment(s), mineral, or natural mineral(s), whether in naturally-occurring states or in otherwise purified or modified states. Some aspects of processes and systems described herein may be particularly useful for iron-containing feedstocks including hematite, maghemite, goethite, magnetite, limonite, siderite, ankerite, turgite, bauxite, or a combination thereof.

Specifically, the iron-containing feedstock may include metallic iron (Fe) and/or one or more iron hydroxides (e.g., Fe(OH)₂, Fe(OH)₃, or the like, or a combination thereof), anhydrous and/or hydrated iron oxyhydroxides (e.g., FeOOH; e.g., FeO(OH)·nH₂O where n is a number of water molecules in the hydrated iron hydroxide molecule, or the like), iron oxides, sub-oxides, mixed oxides, including FeO (wustite), FeO₂ (iron dioxide), a-Fe₂O₃ (hematite), g-Fe₂O₃ (maghemite), Fe₃O₄ (magnetite), Fe₄O₅, Fe₅O₆, Fe₅O₇, Fe₂₅O₃₂, Fe₁₃O₁₉, other iron-containing compounds, a polymorph(s) of these, or a combination of these. For example, in an aspect, the iron-containing feedstock may include hematite (a-Fe₂O₃), maghemite (g-Fe₂O₃), magnetite (Fe₃O₄), goethite (a-FeOOH), limonite (FeOOH·nH₂O), or a combination thereof. In particular aspects, the iron-containing feedstock may include magnetite (Fe₃O₄). In particular aspects, the iron-containing feedstock may include maghemite, magnetite, or a combination thereof. The iron-containing feedstock may be one or more of several sources. In an aspect the iron-containing feedstock may include raw material in the form of hematite, maghemite, magnetite, limonite, siderite, bog-iron ore, clay minerals, ores with concentrations of less than about 30% iron by weight, scrap metals, magnets, slag, fly ash, red mud, a combination thereof, or other materials that have iron as is known by those of ordinary skill in the art.

The iron-containing feedstock may include one or more impurities or minor components. Examples of impurities or minor components may include oxides or complexes of aluminum, magnesium, calcium, carbon, cobalt, chromium, silicon, titanium, phosphorus, sulfur, or a combination thereof. A content of the impurity may be less than 10 weight percent, less than 5 weight percent, less than 1 weight percent, or less than 0.1 weight percent, or less than 0.01 weight percent, based on a total weight of the iron-containing feedstock. In an aspect, a content of the impurity is 0.001 to 10 weight percent, or 0.01 to 4 weight percent, or 0.01 to 1 weight percent, based on a total weight of the iron-containing feedstock.

The iron-containing feedstock in the electrolyte stream may be a slurry or a suspension of iron-containing feedstock particles in the electrolyte material. In an aspect, the electrolyte stream may include 0.1 to 80 weight percent, or 0.1 to 30 weight percent, preferably 0.2 to 10 weight percent, more preferably 0.2 to 2 weight percent of the iron-containing feedstock, based on a total weight of the electrolyte stream. The amount of the iron-containing feedstock in the electrolyte stream may vary based on the type of iron-containing feedstock being used. In an aspect, the iron-containing feedstock may include hematite, wherein the electrolyte stream may include 1 to 30 weight percent, preferably 2 to 30 weight percent, more preferably 10 to 30 weight percent of the iron-containing feedstock, based on a total weight of the electrolyte stream. In an aspect, the iron-containing feedstock may include magnetite, wherein the electrolyte stream may include 0.1 to 30 weight percent, or 0.1 to 10 weight percent, preferably 0.1 to 5 weight percent, more preferably 0.2 to 2 weight percent of the iron-containing feedstock, based on a total weight of the electrolyte stream. In an aspect, the iron-containing feedstock may be present in the electrolyte stream in an amount of at least 5 weight percent, and preferably greater than 10 weight percent, for example, 10 to 80 weight percent, based on a total weight of the electrolyte stream.

The alkaline electrolyte stream further includes an alkaline electrolyte. In an aspect, the electrolyte includes an aqueous solution of an alkali hydroxide. The electrolyte may be a solution including water as a solvent and one or more dissolved hydroxides. For example, the electrolyte may include an aqueous solution of NaOH, KOH, LiOH, CsOH, or a combination thereof. Typically, the electrolyte may include an aqueous solution of NaOH. The alkaline electrolyte can comprise a purified alkaline electrolyte which has been obtained by the method of the present disclosure.

The alkali hydroxide may be present in the aqueous solution in an amount of 20 to 50 weight percent, preferably 30 to 50 weight percent, based on a total weight of the electrolyte. In an aspect, the electrolyte may include an aqueous solution of an alkali hydroxide, wherein the alkali hydroxide may be present in the aqueous solution in an amount of 20 to 50 weight percent, preferably 30 to 50 weight percent, based on a total weight of the electrolyte.

The electrolyte stream may optionally contain additives to promote or inhibit certain desired or undesirable reactions. Any suitable amount of additive(s) may be included in the electrolyte stream. For example, the electrolyte may further include hydrogen evolution reaction suppressor (HER suppressors), an iron activator (e.g., a sulfide salt, such as bismuth sulfide (Bi₂S₃) or sodium sulfide (Na₂S)), or the like, or a combination thereof. In an aspect, the electrolyte may further include an alkali metal sulfide or a polysulfide including one or more of lithium sulfide (Li₂S) or polysulfide (Li₂Sₓ, x=2 to 6), sodium sulfide (Na₂S) or polysulfide (Na₂Sₓ, x=2 to 6), potassium sulfide (K₂S) or polysulfide (K₂Sₓ, x=2 to 6), cesium sulfide (Cs₂S) or polysulfide (Cs₂Sₓ, x=2 to 6), or the like, or a combination thereof. Non-limiting examples of additives include sodium sulfide (Na₂S), potassium sulfide (K₂S), lithium sulfide (Li₂S), iron sulfides (FeSₓ, where x=1-2), bismuth sulfide (Bi₂S₃), lead sulfide (PbS), zinc sulfide (ZnS), antimony sulfide (Sb₂S₃), selenium sulfide (SeS₂), tin sulfides (SnS, SnS₂, Sn₂S₃), nickel sulfide (NiS), molybdenum sulfide (MoS₂), mercury sulfide (HgS), bismuth oxide (Bi₂O₃), or the like, or a combination thereof. In addition, the electrolyte stream may include other additives, including those as described herein and those known in the art.

In an aspect, the HER suppressor additive may include one or more of sodium thiosulfate, sodium thiocyanate, polyethylene glycol (PEG) 1000, trimethylsulfoxonium iodide, zincate (by dissolving ZnO in NaOH), hexanethiol, decanethiol, sodium chloride, sodium permanganate, lead (IV) oxide, lead (II) oxide, magnesium oxide, sodium chlorate, sodium nitrate, sodium acetate, iron phosphate, phosphoric acid, sodium phosphate, ammonium sulfate, ammonium thiosulfate, lithopone, magnesium sulfate, iron(III) acetylacetonate, hydroquinone monomethyl ether, sodium metavanadate, sodium chromate, glutaric acid, dimethyl phthalate, methyl methacrylate, methylpentynol, adipic acid, allyl urea, citric acid, thiomalic acid, N-(2-aminoethyl)-3-aminopropyl trimethoxysilane, propylene glycol, trimethoxysilyl propyl diethylene, aminopropyl trimethoxysilane, dimethyl acetylenedicarboxylate (DMAD), 1,3-diethylthiourea, N,N′-diethylthiourea, aminomethyl propanol, methyl butynol, amino modified organosilane, succinic acid, isopropanolamine, phenoxyethanol, dipropylene glycol, benzoic acid, N-(2-aminoethyl)-3-aminopropyl, behenamide, 2-phosphonobutane tricarboxylic, mipa borate 3-methacryloxypropyltrimethoxysilane, 2-ethylhexoic acid, isobutyl alcohol, t-butylaminoethyl methacrylate, diisopropanolamine, propylene glycol n-propyl ether, sodium benzotriazolate, pentasodium aminotrimethylene phosphonate, sodium cocoyl sarcosinate, laurylpyridinium chloride, steartrimonium chloride, stearalkonium chloride, calcium montanate, quaternium-18 chloride, sodium hexametaphosphate, dicyclohexylamine nitrite, lead stearate, calcium dinonylnaphthalene sulfonate, iron(II) sulfide, sodium bisulfide, pyrite, sodium nitrite, complex alkyl phosphate ester (e.g. RHODAFAC® RA 600 Emulsifier), 4-mercaptobenzioc acid, ethylenediaminetetraacetic acid, ethylenediaminetetraacetate (EDTA), 1,3-propylenediaminetetraacetate (PDTA), nitrilotriacetate (NTA), ethylenediaminedisuccinate (EDDS), diethylenetriaminepentaacetate (DTPA), and other aminopolycarboxylates (APCs), diethylenetriaminepentaacetic acid, 2-methylbenzenethiol, 1-octanethiol, bismuth sulfide, bismuth oxide, antimony(III) sulfide, antimony(III) oxide, antimony(V) oxide, bismuth selenide, antimony selenide, selenium sulfide, selenium(IV) oxide, propargyl alcohol, 5-hexyn-1-ol, 1-hexyn-3-ol, N-allylthiourea, thiourea, 4-methylcatechol, trans-cinnamaldehyde, iron(III) sulfide, calcium nitrate, hydroxylamines, benzotriazole, furfurylamine, quinoline, tin(II) chloride, ascorbic acid, tetraethylammonium hydroxide, calcium carbonate, magnesium carbonate, antimony dialkylphosphorodithioate, potassium stannate, sodium stannate, tannic acid, gelatin, saponin, agar, 8-hydroxyquinoline, bismuth stannate, potassium gluconate, lithium molybdenum oxide, potassium molybdenum oxide, hydrotreated light petroleum oil, heavy naphthenic petroleum oil (e.g. sold as Rustlick® 631), antimony sulfate, antimony acetate, bismuth acetate, hydrogen-treated heavy naphtha (e.g. sold as WD-40), tetramethylammonium hydroxide, NaSb tartrate, urea, D-glucose, C₆Na₂O₆, antimony potassium tartrate, hydrazinesulphate, silica gel, triethylamine, potassium antimonate trihydrate, sodium hydroxide, 1,3-di-o-tolyl-2-thiourea, 1,2-diethyl-2-thiourea, 1,2-diisopropyl-2-thiourea, N-phenylthiourea, N,N′-diphenylthiourea, sodium antimony L-tartrate, rhodizonic acid disodium salt, sodium selenide, or the like, or a combination thereof.

In an aspect, the electrolyte stream may further include a solid conductive additive. In an embodiment, the electrolyte stream may further include carbon in an amount from 0.01 to 10 weight percent, based on a total weight of the electrolyte stream.

The electrochemical cell electrochemically reduces at least a portion of the iron-containing feedstock to produce a plurality of iron particles at a surface of the cathode.

The electrochemical reactor may be operated at a temperature of 50° C. to 140° C., preferably 70° C. to 120° C., more preferably 85° C. to 110° C. For example, the electrolyte stream may be at a temperature of 50° C. to 140° C., preferably 70° C. to 120° C., more preferably 85° C. to 110° C. before the electrolyte stream is introduced to the electrochemical reactor, such that the temperature of the electrolyte stream in the electrochemical reactor may be 50° C. to 140° C., preferably 70° C. to 120° C., more preferably 85° C. to 110° C.

The operating temperature of the electrolyte in the electrochemical reactor may be controlled through any one or more of a variety of means, including, for example, heat exchange, an immersion heating element, an in-line heating device (e.g., a heat exchanger), or the like, preferably coupled with one or more feedback temperature control means for efficient process control. The operating temperature of the electrolyte in the electrochemical reactor may be achieved through self-heating of the electrochemical reactor due to heat generation associated with operating at less than 100% energy efficiency. In the case of self-heating, a cooling system may be implemented to prevent the electrochemical cell from reaching temperatures greater than the optimal operating range.

In an aspect, a current density at the cathode for the reduction of the iron-containing feedstock may be 40 to 5,000 milliamperes per square centimeter (mA/cm²), preferably 150 to 1,000 mA/cm². In an aspect, the current density at the cathode may be selected to promote the formation of iron dendrites at the surface of the cathode. The current density may be periodically pulsed, modulated, or a combination of pulsing and modulation to control the iron metal dendrite growth or to limit the competing HER at the cathode.

The electrochemical reactor may operate with a suitable fluid flow, which may be varied based on operating conditions. The fluid flow may be a laminar flow, a turbulent flow, or a combination thereof. The fluid flow may be present as a flow rate. Any suitable flow rate may be used. The flow rate may include, but is not limited to, at least 0.01 liters per minute per square meter of cathode area (L/min/m²), for example, 0.05 to 5 L/min/m², or 0.1 to 2.5 L/min/m².

In an aspect, the channel may be arranged substantially parallel to gravity. For example, the channel may be arranged to provide a vertical flow channel relative to the ground.

The method further comprises separating at least a portion of the plurality of iron particles from the alkaline electrolyte. Thus the electrochemical reactor further includes a separation unit that is disposed downstream of the channel. The separation unit may be configured to separate at least a portion of the iron metal from the electrolyte stream, for example after the electrochemical reduction of the iron-containing feedstock. In the separation unit, at least a portion of the iron metal can be separated from the electrolyte stream.

The separated electrolyte stream can be purified, for example according to the method described herein. The purified electrolyte stream can be recirculated back to an upstream region of the electrochemical cell, such as into a mixing tank, and can be re-used in the processing of an iron-containing feedstock.

An exemplary reactor and method for processing an iron-containing feedstock can be as shown in FIG. 2. As shown in FIG. 2, the electrochemical reactor system 2000 comprises an electrochemical reactor 200, a feedstock handling system 201, and a product handling system 202. The electrochemical reactor 200 includes a cathode and an anode (not shown). The anode and the cathode are in contact with an electrolyte stream including an iron-containing feedstock. The electrolyte stream is provided to the electrochemical reactor by the feedstock handling system 201. The feedstock handling system 201 can include a mixing tank 203 for mixing a concentrated ore slurry from a concentrated ore unit 204 with an electrolyte from an electrolyte unit 205. Electrolyte purification unit 206 can provide electrolyte purification, and can be, for example, as shown in FIG. 1.

From the electrochemical reactor 200 an electrolyte product stream 207 including the electrolyte, and optionally the iron metal product or unreacted iron-containing feedstock particles, to the product handling system 202. The product handling system may optionally include a separation unit 208. The separation unit 208 may be configured to separate the iron metal product from unreacted iron-containing feedstock material, and may include a magnetic separator or a physical separator. The product handling system 202 may optionally include a post processing unit 209. The post processing unit 209 may wash or dry the product. The product handling system 202 may also include residuals separation unit 210 configured to separate residual iron-containing feedstock from the electrolyte stream. The residual iron-containing feedstock 211 may be provided by the concentrated ore slurry to the concentrated ore unit 204 and the electrolyte 212 provided to the electrolyte unit 205 after passing through the electrolyte purification unit 206. Thus the electrolyte stream can be recirculated back to an upstream region of the reactor, such as into the mixing tank 203.

A significant improvement is therefore provided by the present disclosure.

### EXAMPLES

### Example 1

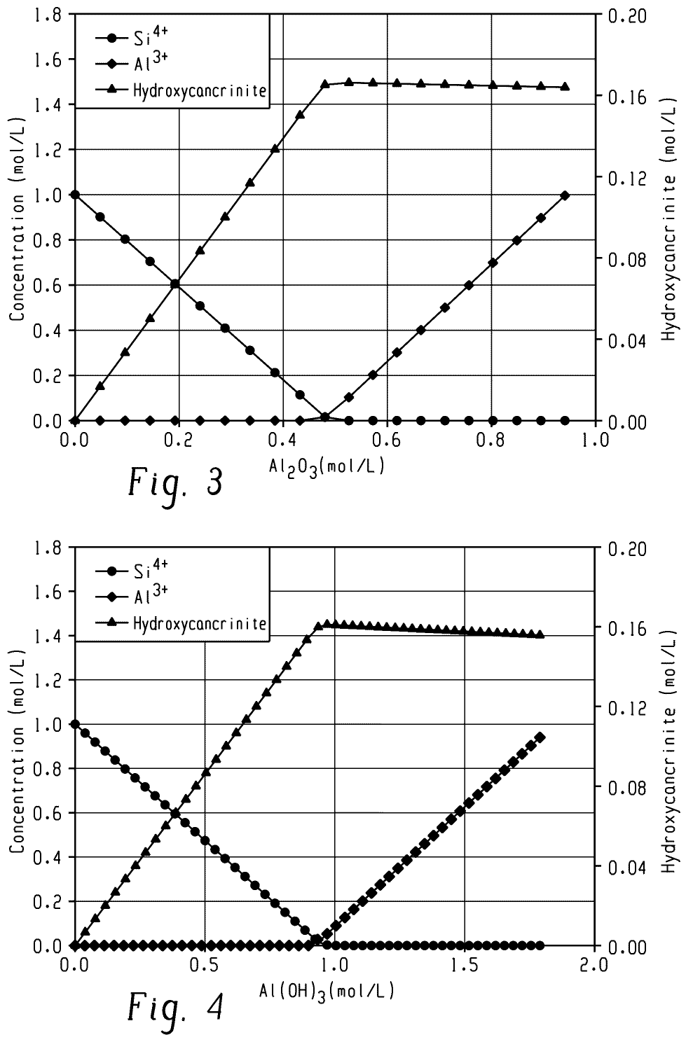

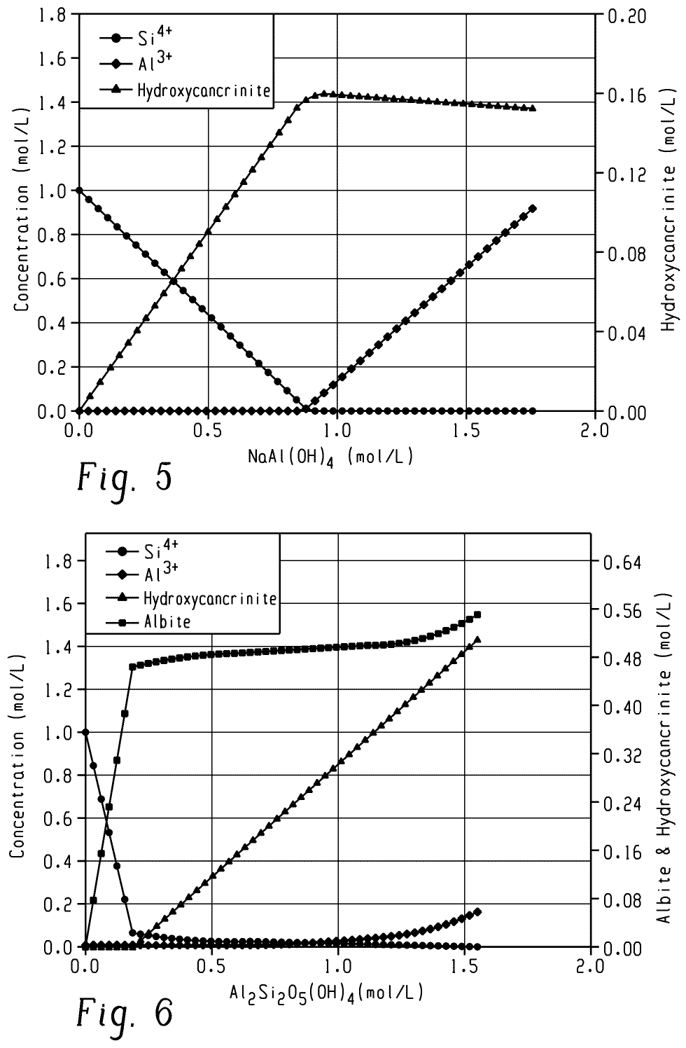

A thermodynamic simulation of the purification process of sodium hydroxide solution/electrolyte using OLI Studio 11.5 Software is shown in FIGS. 3-6. The simulated electrolyte stream included 6.5 molar sodium hydroxide and 1 molar of dissolved silicon dioxide. The purification process was simulated at 90° C. and 1 atmosphere (atm). The simulation shows removal of dissolved silicon by addition of an aluminum oxide or aluminum hydroxide or sodium aluminate or kaolin or calcium aluminate or other aluminates, as shown in sample Equations (5)-(7), which shows the potential formation of a zeolite type of compound like sodalite, hydroxysodalite, cancrinite, hydroxycancrinite, cancrinite monohydrate, etc. Other aluminosilicates (Equation (8)) like albite, NaASi₃O₈, may also be formed depending on the on the concentration of the added aluminate compound and the conditions in the reactor.

6SiO₂(s)+8NaOH(aq)+3Al₂O₃(s)→3H₂O(l)+Na₈Al₆Si₆O₂₄(OH)₂(s) (5)

6SiO₂(s)+8NaOH(aq)+6Al(OH)₃(aq)→12H₂O(l)+Na₈Al₆Si₆O₂₄(OH)₂(s) (6)

12Na₂SiO₃(aq)+12NaAl(OH)₄(aq)+15H₂O(l)→Na₁₂((Al₂)₁₂(SiO₂)₁₂)·27H₂O(s)+24NaOH(aq) (7)

4SiO₂(aq)+2NaOH(aq)+Al₂Si₂O₅(OH)₄(aq)→3H₂O(l)+2NaAlSi₃O₈(s) (8)

Al₂O₃ (1 gram) or an equivalent amount of aluminum (depending on the aluminum compound added) per gram of dissolved SiO₂ is needed to remove approximately 99% of silicon dissolved in a sodium hydroxide solution or electrolyte.

As shown in FIG. 3-6, the dissolved silicon, Si⁴⁺ concentration decreases with increasing concentration of Al₂O₃, Al(OH)₃, NaAl(OH)₄, and Al₂Si₂O₅(OH)₄ added, respectively. Hydroxycancrinite and albite concentration increases until the Si⁴⁺ concentration reaches approximately zero.

### Example 2: Effect of Electrolyte Concentration

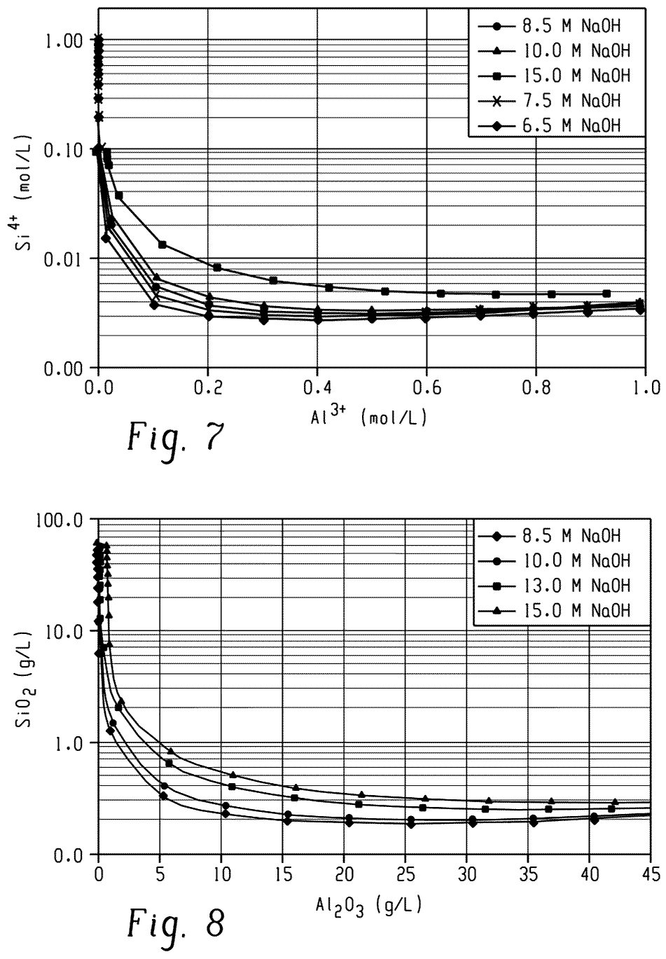

The effect of sodium hydroxide concentration on the purification process was examined using thermodynamic simulations using OLI Studio 11.5. The simulated electrolyte stream included sodium hydroxide in concentrations ranging from 6.5 molar to 15 molar. The purification process was simulated at 90° C. and 1 atm. FIG. 7 shows the stability regions of dissolved silicon (Si⁴⁺) and aluminum (Al³⁺) in a sodium hydroxide solution or electrolyte. FIG. 8 shows the stability diagram of dissolved silicon (SiO₂) and aluminum (Al₂O₃) in a sodium hydroxide solution or electrolyte. FIGS. 7 and 8 show that below the curve, desilication (silicon removal) does not occur and above the curve, desilication occurs (silicon is removed from electrolyte by precipitation of a zeolite type of compound). FIGS. 7 and 8 show operating curves or control curves including areas where dissolved aluminum-silicon combination is favorable for alkaline electrowinning (area below the curve) and which is unfavorable for alkaline electrowinning (area above the curve). In some embodiments, lower concentration of electrolyte favor desilication (purification) for the same amount of added aluminum (adjusted for differences in the type of aluminum compound added). In some embodiments, higher electrolyte concentration may potentially favor less desilication (purification) and this may provide a wider alkaline electrowinning operating zone.

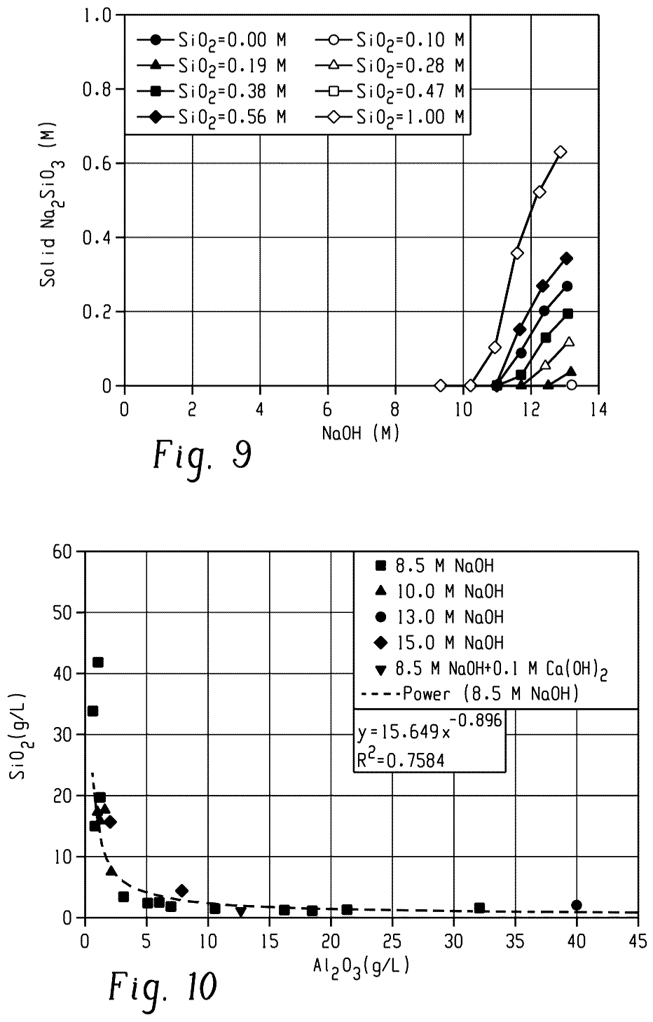

FIG. 9 shows that NaOH concentrations higher than 10 molar react differently to dissolved silicon and can form sodium silicate which may affect alkaline electrolyte conductivity during electrowinning. This shows a potential sodium hydroxide/electrolyte concentration regime that may be advantageous to successful alkaline electrowinning in cases where silicon is dissolved.

### Example 3: Experimental Results of Alkaline Electrolyte Purification

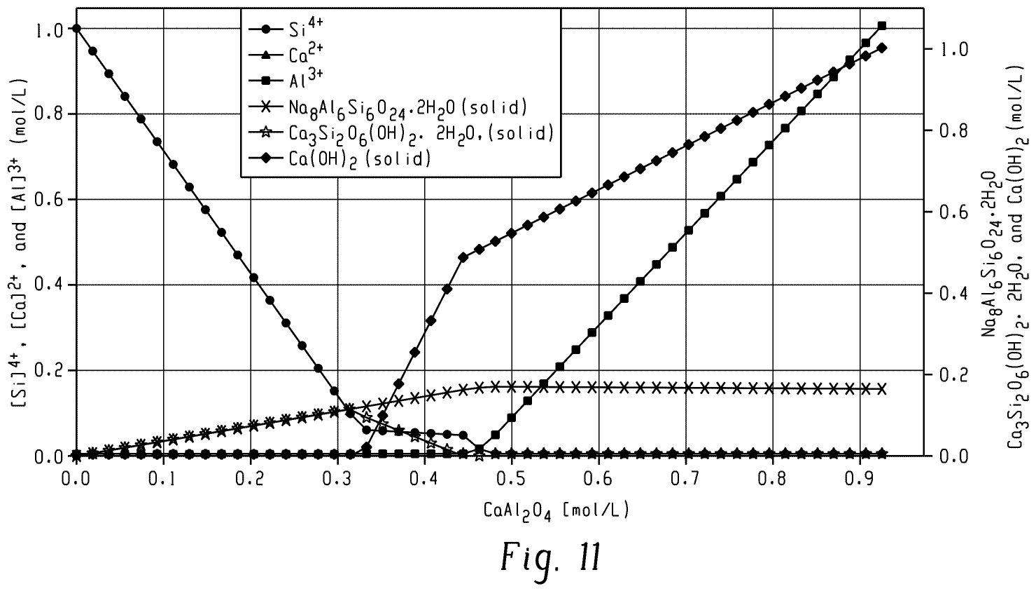

Alkaline electrolytes having varying concentrations of sodium hydroxide (8.5 to 13 molar NaOH) were purified by addition of aluminum hydroxide, Al(OH)₃. The X-axis has been converted to equivalent alumina (Al₂O₃) concentration for comparison with simulation results in FIG. 3. The purification was conducted at 90° C. and 1 atm. The results are shown in FIG. 10. As shown in FIG. 10, dissolved silicon dioxide concentration in the NaOH electrolyte was observed to decrease with increasing concentrations of Al₂O₃. The concentration of NaOH seems to have a small but significant impact on the desilication (purification) process has it pushes the desilication control curve higher. At any given amount of dissolved aluminum in the electrolyte during alkaline electrowinning, high concentrations of NaOH may allow higher concentrations of silicon to build up in the electrolyte before spontaneous crystallization of zeolite in the cell. This may allow running the electrolysis cell for longer hours before harvesting of the iron product. The experimental data shown in FIG. 10 was also observed to correlate with the FIG. 8 simulation results. Furthermore, calcium hydroxide or oxide may be added to enhance the purification process. FIG. 10 show that addition of Ca(OH)₂ may further lower the amount of residual dissolved silicon when added in combination with an aluminum containing compound. Additionally, FIG. 11 is an OLI Studio simulation, illustrating the effect of adding calcium aluminate (CaAl₂O₄) to a 6.5 molar NaOH electrolyte at 90° C., 1 atm containing 1 molar dissolved SiO₂. Similar purification results are obtained as in using an aluminum oxide, hydroxide, or sodium aluminate.

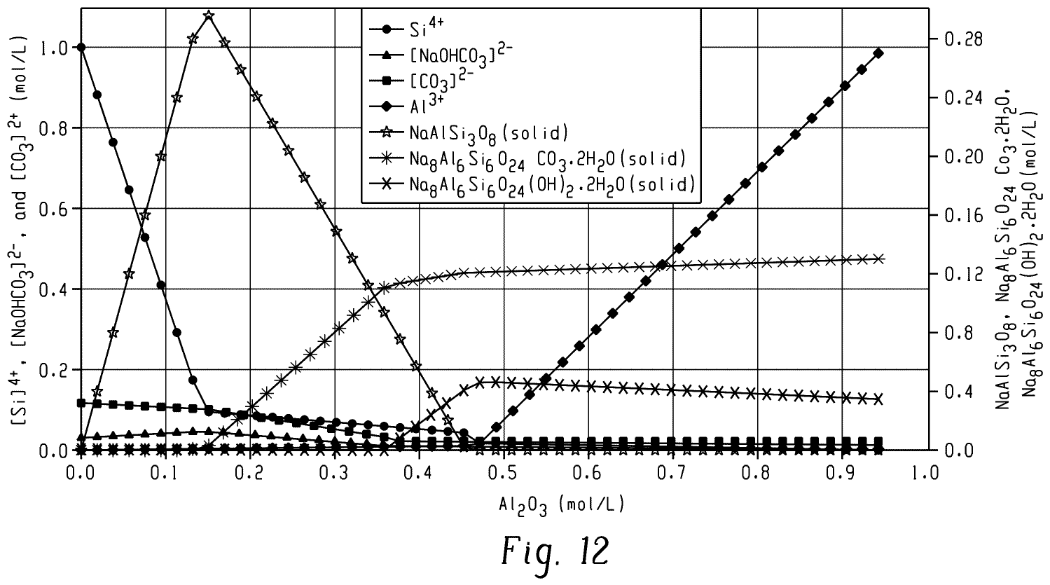

Similarly, anionic impurities may build up during alkaline electrowinning of iron ore. These include but are not limited to carbonates, sulfates, oxalates, chlorides, fluorides, etc. These can be removed from the electrolyte using the same processes described above (FIGS. 3-6). Equation (9) illustrates the reaction which occurs during this purification process. FIG. 12 is an OLI Studio 11.5 simulation of the removal of 0.15 molar dissolved carbonate from a 6.5 molar NaOH electrolyte at 90° C., 1 atm. containing 1 molar dissolved SiO₂.

6NaAl(OH)₄(aq)+6Na₂SiO₃(aq)+Na₂X(aq)→Na₆[Al₆Si₆O₂₄]·3(H₂O)(s)+12NaOH(aq)+3H₂O(l) (9)
Where X=SO₄²⁻, CO₃²⁻, C₂O₄²⁻, 2Al(OH)⁴⁻, 2Cl⁻, 2OH⁻, F⁻, etc.

This disclosure further encompasses the following aspects.

Aspect 1: A method of purifying an alkaline electrolyte, the method comprising: providing the alkaline electrolyte, wherein the alkaline electrolyte comprises a metal hydroxide, a compound comprising aluminum, silicon, or a combination thereof, and a solvent; and contacting the alkaline electrolyte with an aluminum compound to provide a purified alkaline electrolyte.

Aspect 2: The method of aspect 1, wherein the alkaline electrolyte has a pH of 9 to 17.5.

Aspect 3: The method of aspect 1 or 2, wherein the alkaline electrolyte has a total hydroxide concentration of greater than 1 molar, preferably 2 molar to 15 molar, more preferably 4 molar to 8 molar, or wherein the alkaline electrolyte has a total hydroxide concentration of less than 10 molar, preferably 2 molar to 9 molar, more preferably 4 molar to 8 molar, or wherein the alkaline electrolyte has a total hydroxide concentration of 5 molar to 20 molar, preferably 10 molar to 20 molar, more preferably 10 molar to 19 molar, each based on a total volume of the alkaline electrolyte.

Aspect 4: The method of any of aspects 1 to 3, wherein the alkaline electrolyte comprises an alkali metal hydroxide.

Aspect 5: The method of any of aspects 1 to 3, wherein the alkaline electrolyte comprises sodium hydroxide, potassium hydroxide, lithium hydroxide, cesium hydroxide, or a combination thereof, preferably sodium hydroxide.

Aspect 6: The method of any of aspects 1 to 5, wherein the compound comprising aluminum, silicon, or a combination thereof comprises Al₂O₃·2SiO₂·2H₂O, SiO₂, Al(OH)₃, (MgₓFe₁₋ₓ)₃Si₄O₁₀(OH)₂ wherein 0≤x≤1, KAlSi₃O₈, (KₘNaₙCaₒ)0.6(MgₚFe²⁺_{q}Fe³⁺_{1-q})6Si₈Al(OₛOH₁₋ₛ)₂₄·2H₂O wherein 0≤m≤1, 0≤n≤1, 0≤o≤1 and m+n+o=1, 0≤p≤1, 0≤q≤1, and p+q=1, and 0≤s≤1, NaAlSi₃O₈, or a combination thereof.

Aspect 7: The method of any of aspects 1 to 6, wherein the alkaline electrolyte further comprises an anionic impurity comprising SO₄²⁻, CO₃²⁻, C₂O₄²⁻, 2Al(OH)₄⁻, 2Cl⁻, 2OH⁻, F⁻, or a combination thereof.

Aspect 8: The method of any of aspects 1 to 7, wherein the solvent is an aqueous solvent, preferably water.

Aspect 9: The method of any of aspects 1 to 8, wherein the aluminum compound comprises aluminum oxide, aluminum hydroxide, sodium aluminate, kaolin, calcium aluminate, or a combination thereof.

Aspect 10: The method of any of aspects 1 to 8, wherein the aluminum compound comprises sodium aluminate.

Aspect 11: The method of any of aspects 1 to 10, wherein the aluminum compound is added to the alkaline electrolyte in an amount effective to provide a weight ratio of aluminum compound:dissolved silicon of 0.75:1 to 1.75:1.

Aspect 12: The method of any of aspects 1 to 11, wherein the aluminum compound, when contacted with the compound comprising aluminum, silicon, or a combination thereof, forms an aluminum compound, a silicon compound, an aluminosilicate compound, or a combination thereof, preferably an aluminosilicate compound.

Aspect 13: The method of aspect 12, wherein the aluminum compound, a silicon compound, an aluminosilicate compound, or a combination thereof precipitates out of the alkaline electrolyte, preferably wherein the compound is the aluminosilicate compound.

Aspect 14: The method of any of aspects 1 to 13, wherein the compound comprising aluminum, silicon, or a combination thereof comprises a silicon oxide.

Aspect 15: The method of any of aspects 1 to 14, wherein the contacting is at a temperature of 50 to 200° C., at a pressure of greater than or equal to 1 atmosphere, or a combination thereof.

Aspect 16: The method of any of aspects 1 to 15, further comprising contacting the alkaline electrolyte with an alkaline earth metal compound, preferably a calcium compound.

Aspect 17: The method of aspect 16, wherein the calcium compound comprises a calcium oxide, a calcium hydroxide, or a combination thereof.

Aspect 18: The method of any of aspects 1 to 17, further comprising contacting the alkaline electrolyte with activated carbon.

Aspect 19: The method of any of aspects 1 to 18, further comprising contacting the alkaline electrolyte with an ion exchange resin.

Aspect 20: The method of any of aspects 1 to 19, further comprising crystallization.

Aspect 21: The method of any of aspects 1 to 20, further comprising contacting the alkaline electrolyte with sodium carbonate.

Aspect 22: The method of any of aspects 1 to 21, wherein the purified alkaline electrolyte has a residual silicon concentration of less than 0.02 molar, based on a total volume of the alkaline electrolyte.

Aspect 23: The method of any of aspects 1 to 22, wherein the purified alkaline electrolyte has a residual aluminum concentration of less than 0.11 molar, based on a total volume of the alkaline electrolyte.

Aspect 24: The method of any of aspects 1 to 23, wherein the purified alkaline electrolyte has a residual silicon concentration that is 10% or less, or 5% or less, or 2% or less, or 1% or less of an initial concentration of the compound comprising silicon.

Aspect 25: The method of any of claims 1 to 24, wherein the alkaline electrolyte has a dissolved Al₂O₃ concentration of less than 100 grams per liter, or less than 50 grams per liter.

Aspect 26: A method of processing an iron-containing feedstock to produce an iron particle, the method comprising: continuously flowing an alkaline electrolyte stream comprising the iron-containing feedstock through a channel of an electrochemical cell, the electrochemical cell comprising an anode, and a cathode disposed in the channel; electrochemically reducing at least a portion of the iron-containing feedstock to produce a plurality of iron particles at a surface of the cathode; separating at least a portion of the plurality of iron particles from the alkaline electrolyte; purifying the alkaline electrolyte according to the method of any of aspects 1 to 25 to provide a purified alkaline electrolyte; and recycling the purified alkaline electrolyte to the alkaline electrolyte stream to process the iron-containing feedstock.

Aspect 27: An alkaline electrolyte purifier, comprising a mixing unit having a first inlet configured to receive an alkaline electrolyte feedstock, the alkaline electrolyte feedstock comprising a metal hydroxide, a compound comprising aluminum, silicon, or a combination thereof, and a solvent, a second inlet configured to receive a precipitant comprising an aluminum compound, and an outlet configured to provide a slurry; and a first separator configured to separate the slurry and provide a solid component and a first alkaline electrolyte stream.

Aspect 28: The alkaline electrolyte purifier of aspect 27, further comprising an ion exchange unit configured to receive the first alkaline electrolyte stream from the first separator to provide a second alkaline electrolyte stream.

Aspect 29: The alkaline electrolyte purifier of aspect 27 or 28, further comprising an adsorption unit configured to receive the first alkaline electrolyte stream from the first separator, wherein the adsorption unit comprises activated carbon; and a second separator configured to separate the first alkaline electrolyte stream and the activated carbon and provide a third alkaline electrolyte stream.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, which are otherwise not necessary to the achievement of the function or objectives of the compositions, methods, and articles.

All ranges disclosed herein are inclusive of the endpoints, and the endpoints are independently combinable with each other (e.g., ranges of “up to 25 wt %, or, more specifically, 5 wt % to 20 wt %”, is inclusive of the endpoints and all intermediate values of the ranges of “5 wt % to 25 wt %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments,” “an embodiment,” “an aspect,” and so forth, means that a particular element described in connection with the embodiment and/or aspect is included in at least one embodiment and/or aspect described herein, and may or may not be present in other embodiments and/or aspects. In addition, it is to be understood that the described elements may be combined in any suitable manner in the various embodiments and/or aspects. A “combination thereof” is open and includes any combination comprising at least one of the listed components or properties optionally together with a like or equivalent component or property not listed.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art.

1. A method of purifying an alkaline electrolyte, the method comprising:
providing the alkaline electrolyte, wherein the alkaline electrolyte comprises
a metal hydroxide,
a compound comprising aluminum, silicon, or a combination thereof, and
a solvent; and
contacting the alkaline electrolyte with an aluminum compound to provide a purified alkaline electrolyte.

2. The method of claim 1, wherein the alkaline electrolyte has a pH of 9 to 17.5.

3. The method of claim 1,
wherein the alkaline electrolyte has a total hydroxide concentration of greater than 1 molar, or
wherein the alkaline electrolyte has a total hydroxide concentration of less than 10 molar, or
wherein the alkaline electrolyte has a total hydroxide concentration of 5 molar to 20 molar,
each based on a total volume of the alkaline electrolyte.

4. The method of claim 1, wherein the alkaline electrolyte comprises an alkali metal hydroxide.

5. The method of claim 1, wherein the alkaline electrolyte comprises sodium hydroxide, potassium hydroxide, lithium hydroxide, cesium hydroxide, or a combination thereof.

6. The method of claim 1, wherein the compound comprising aluminum, silicon, or a combination thereof comprises Al₂O₃·2SiO₂·2H₂O, SiO₂, Al(OH)₃, (MgₓFe₁₋ₓ)₃Si₄O₁₀(OH)₂ wherein 0≤x≤1, KAlSi₃O₈, (KₘNaₙCaₒ)0.6(MgₚFe²⁺_{q}Fe³⁺_{1-q})6Si₈Al(OₛOH₁₋ₛ)₂₄·2H₂O wherein 0≤m≤1, 0≤n≤1, 0≤o≤1 and m+n+o=1, 0≤p≤1, 0≤q≤1, and p+q=1, and 0≤s≤1, NaAlSi₃O₈, or a combination thereof.

7. The method of claim 1, wherein the alkaline electrolyte further comprises an anionic impurity comprising SO₄²⁻, CO₃²⁻, C₂O₄²⁻, 2Al(OH)₄⁻, 2Cl⁻, 2OH⁻, F⁻, or a combination thereof.

8. The method of claim 1, wherein the solvent is an aqueous solvent.

9. The method of claim 1, wherein the aluminum compound comprises aluminum oxide, aluminum hydroxide, sodium aluminate, kaolin, calcium aluminate, or a combination thereof.

10. The method of claim 1, wherein the aluminum compound comprises sodium aluminate.

11. The method of claim 1, wherein the aluminum compound is added to the alkaline electrolyte in an amount effective to provide a weight ratio of aluminum compound:dissolved silicon of 0.75:1 to 1.75:1.

12. The method of claim 1, wherein the aluminum compound, when contacted with the compound comprising aluminum, silicon, or a combination thereof, forms an aluminum compound, a silicon compound, an aluminosilicate compound, or a combination thereof.

13. The method of claim 1, wherein the aluminum compound, a silicon compound, an aluminosilicate compound, or a combination thereof precipitates out of the alkaline electrolyte.

14. The method of claim 1, wherein the compound comprising aluminum, silicon, or a combination thereof comprises a silicon oxide.

15. The method of claim 1, wherein the contacting is at a temperature of 50 to 200° C., at a pressure of greater than or equal to 1 atmosphere, or a combination thereof.

16. The method of claim 1, further comprising one or more of contacting the alkaline electrolyte with an alkaline earth metal compound; or
contacting the alkaline electrolyte with activated carbon; or
contacting the alkaline electrolyte with an ion exchange resin; or
crystallization; or
contacting the alkaline electrolyte with sodium carbonate.

17. The method of claim 1, wherein the purified alkaline electrolyte has a residual silicon concentration of less than 0.02 molar, based on a total volume of the alkaline electrolyte.

18. The method of claim 1, wherein the purified alkaline electrolyte has a residual aluminum concentration of less than 0.11 molar, based on a total volume of the alkaline electrolyte.

19. The method of claim 1, wherein the purified alkaline electrolyte has a residual silicon concentration that is 10% or less of an initial concentration of the compound comprising silicon.

20. The method of claim 1, wherein the alkaline electrolyte has a dissolved Al₂O₃ concentration of less than 100 grams per liter.

21. A method of processing an iron-containing feedstock to produce an iron particle, the method comprising:
continuously flowing an alkaline electrolyte stream comprising the iron-containing feedstock through a channel of an electrochemical cell, the electrochemical cell comprising an anode, and a cathode disposed in the channel;
electrochemically reducing at least a portion of the iron-containing feedstock to produce a plurality of iron particles at a surface of the cathode;
separating at least a portion of the plurality of iron particles from the alkaline electrolyte;
purifying the alkaline electrolyte according to the method of claim 1 to provide a purified alkaline electrolyte; and
recycling the purified alkaline electrolyte to the alkaline electrolyte stream to process the iron-containing feedstock.

22. An alkaline electrolyte purifier, comprising
a mixing unit having
a first inlet configured to receive an alkaline electrolyte feedstock, the alkaline electrolyte feedstock comprising
a metal hydroxide,
a compound comprising aluminum, silicon, or a combination thereof, and
a solvent,
a second inlet configured to receive a precipitant comprising an aluminum compound, and
an outlet configured to provide a slurry; and
a first separator configured to separate the slurry and provide a solid component and a first alkaline electrolyte stream.

23. The alkaline electrolyte purifier of claim 22, further comprising
an ion exchange unit configured to receive the first alkaline electrolyte stream from the first separator to provide a second alkaline electrolyte stream.

24. The alkaline electrolyte purifier of claim 22, further comprising
an adsorption unit configured to receive the first alkaline electrolyte stream from the first separator, wherein the adsorption unit comprises activated carbon; and
a second separator configured to separate the first alkaline electrolyte stream and the activated carbon and provide a third alkaline electrolyte stream.
